(19) United States
(12) Patent Application Publication
(10) Pub. No.: US 2022/0358099 A1
(43) Pub. Date: Nov. 10, 2022

(54) AUTOMATED FIT-FOR-DATA DATABASE

(71) Applicant: Red Equation Corp., Hauppauge, NY (US)

(72) Inventor: Ali Koc, Smithtown, NY (US)

(21) Appl. No.: 17/316,575

(22) Filed: May 10, 2021

(51) Int. Cl. G06F 16/21

(52) U.S. Cl. CPC G06F 16/211

(57) ABSTRACT

The present invention relates to a method of creating fit-for-data databases based on a user's input, and a system used for carrying out said method. Said databases may be used to store and/or retrieve various types of data that may exist in one or more non-transient, computer-readable forms. The invention may modify the user's input and compile said input into binary in order to create fit-for-data databases. Said databases may be deployed in a development, QA, or a production environment. Said databases may comprise ingestion interfaces and data technology query interfaces that a user may use to add data to the databases and retrieve data from the databases.

### BACKGROUND OF INVENTION

In the field of database technology, many general-purpose databases exist to store and retrieve data. Said data may exist in one or more non-transient, computer-readable forms. One advantage of general-purpose databases is that they may be used for a variety of different purposes. However, due to the nature of being “general-purpose,” said general purpose databases are not ideal for any specific purpose.

To overcome this deficiency, many special-purpose, or “fit-for-purpose,” databases exist that are used for one specific purpose. For example, one fit-for-purpose database may be used by a healthcare organization to store and retrieve patient-centric data such as patient name, date of birth, health history, current prescriptions, etc. Another fit-for-purpose database may be used by a financial institution to store and retrieve account-centric data such as current account value, transaction history, and current account investments.

One advantage of fit-for-purpose databases are that they may be configured for a specific purpose, and thus are able to store more data and retrieve said data faster than a general-purpose database. However, fit-for-purpose databases can be expensive to develop and maintain. Furthermore, fit-for-purpose databases only work for the purpose for which they are built. That is to say that if a fit-for-purpose database is built for a specific data schema and/or query mechanism, said database will only work for that particular data schema and/or query mechanism. If a user of said database wishes to change the data schema and/or query mechanism, the entire database must be re-developed.

To overcome the deficiencies in the art described herein, there exists a need in the art for one system that is able to take inputs from a user and automatically create a fit-for-purpose database that fits the exact needs of the user. Said system should be able to create a database from scratch using a provided schema and source code template, and should not require an existing database and/or existing data in order to create a fit-for-purpose database. Furthermore, said system should be able to create multiple fit-for-purpose databases using multiple different schemas and source code templates. Since said databases would be created to fit the specific data rather than the data being formatted/transformed to fit the databases, said databases may be referred to as “fit-for-data” databases.

### SUMMARY OF INVENTION

The present invention relates to a method of creating fit-for-data databases based on a user's input, and a system used for carrying out said method. Said databases may be used to store and/or retrieve various types of data that may exist in one or more non-transient, computer-readable forms.

The invention may modify the user's input and compile said input into binary in order to create fit-for-data databases. Said databases may be deployed in a development, QA, or a production environment. Said databases may comprise ingestion interfaces and data technology query interfaces that a user may use to add data to the databases and retrieve data from the databases.

### BRIEF DESCRIPTION OF DRAWINGS

FIG. 1 is a flowchart that illustrates the steps of creating fit-for-data databases in some embodiments of the invention

### DETAILED DESCRIPTION

The description provided herein describes various embodiments of the invention, and is not intended to limit the invention to any particular embodiments, features, components, or steps. The drawings provided herein are for exemplary purposes and are not intended to limit the invention to any particular embodiments, features, components, or steps.

Various terms are used in this description to describe feature of the invention, said terms being but not limited to “fit-for-data database”, “database”, “database management system”, “data schema”, “data technology source code template”, “environment”, “ingestion interface”, and “query interface.” Said terms may be referred to in the singular or plural form. This should not be interpreted as limiting the invention to either a single existence or to multiple existences of said features of the invention. An important feature of the invention in preferred embodiments is the ability to automatically create multiple fit-for-data databases using one or more inputted schemas and one or more inputted data technology source code templates.

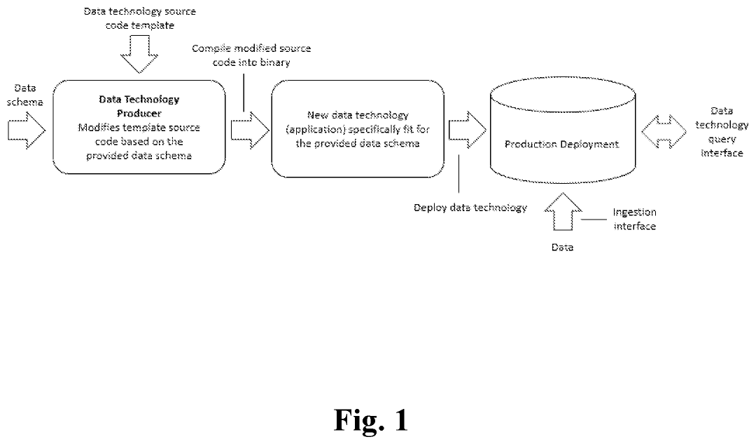

FIG. 1 illustrates the steps carried out in some embodiments of the invention in order to automatically create fit-for-data databases. A user may provide a data schema and data technology source code template to the data technology producer of the invention. The data technology source code template may be provided to the data technology producer in any programming language or non-transient, computer-readable medium. Some embodiments of the invention use the Rust programming language as the data technology source code template input. The Rust programing language is known to provide superior memory-safety, and speed to other programming languages in the art.

The data technology producer uses the data schema provided by the user to modify the data technology source code template to fit the needs of the user. The invention then compiles the modified source code into binary. In other embodiments, the invention may compile the modified source code into other forms of non-transient, computer-readable media.

Compiling the modified source code creates the fit-for-data database. Once created, the fit-for-data database may be deployed to a production environment of a computer program in order to be used by a user. In some embodiments, the fit-for-data database may be deployed in a development or QA environment of a computer program prior to and/or after being deployed to the production environment.

Creating and deploying the fit-for-data database may comprise the creation of a fit-for-data data ingestion interface that may be used to enter data into the fit-for-data database. In some embodiments, the creation of the data ingestion interface may be created after the fit-for-data database is deployed.

The invention may further use the data schema and data technology source code template to determine the proper data technology query interface, meaning that the query interface for the fit-for-data database may also be fit-for-data. This allows a user skilled in the art of whatever data technology is used to easily write queries for the fit-for-data database, even if the user is not proficient in a database language (i.e. SQL). Said data technology query interface may be created either prior to or after deployment of the fit-for-data database.

Since the invention described herein may comprise a database, an ingestion interface, and a query interface, the entity referred to as the “fit-for-data database” herein may also be referred to as a database management system (DBMS), “database management system” taking the meaning as known in the art of data technology.

The invention as described herein may be implemented on a general-purpose computer, special-purpose computer, or any other device capable of reading non-transitory, computer-readable media. Said other devices may be portable computer devices such as smartphones or tablets.

1. A database management system comprising:
a data technology producer,
wherein the data technology producer takes one or more data schemas and one or more data technology source code templates as inputs and outputs one or more fit-for-data databases.

2. The database management system of claim 1, wherein the data technology producer modifies the one or more data technology source code templates based on the one or more data schemas.

3. The database management system of claim 2, wherein the data technology producer further compiles the one or more data technology source code templates into binary.

4. The database management system of claim 3, wherein the one or more fit-for-data databases are deployed in one or more production environments.

5. The database management system of claim 4, further comprising:
one or more ingestion interfaces; and
one or more data technology query interfaces.

6. The database management system of claim 5, wherein data may be entered into the one or more fit-for-data databases by use of the one or more ingestion interfaces.

7. The database management system of claim 6, wherein the one or more data technology source code templates are provided using the Rust programming language.

8. A method of creating one or more fit-for-data databases, comprising:
providing one or more data schemas and one or more data technology source code templates to a data technology producer;
modifying the one or more data technology source code templates based on the one or more data schemas; and
compiling the one or more data technology source code templates into binary to create the one or more fit-for-data databases.

9. The method of claim 8, further comprising deploying the one or more fit-for-data databases in one or more production environments.

10. The method of claim 9, further comprising adding one or more ingestion interfaces and one or more data technology query interfaces to the one or more fit-for-data databases.

11. The method of claim 10, further comprising adding data to the one or more fit-for-data databases by use of the one or more ingestion interfaces.

12. The method of claim 11, wherein the one or more data technology source code templates are provided using the Rust programming language.
